(19) United States
(12) Patent Application Publication
(10) Pub. No.: US 2013/0080200 A1
(43) Pub. Date: Mar. 28, 2013

(54) ANALYZING AND PRESENTING SUPPLY, FABRICATION, AND LOGISTICS DATA

(71) Applicant: FLEXTRONICS AP, LLC, Broomfield, CO (US)

(72) Inventors: Jonathon Connolly, Ottawa (CA); Caroline Dowling, Gurteen (IE); Tom Fletcher, San Jose, CA (US); Edward M. Hancock, Penfield, NY (US); Eoghan Maher, Glanmire (IE); Akhil Oltikar, San Diego, CA (US); Payton Patterson, Collierville, TN (US)

(73) Assignee: FLEXTRONICS AP, LLC, Broomfield, CO (US)

(21) Appl. No.: 13/630,153

(22) Filed: Sep. 28, 2012

Related U.S. Application Data
(60) Provisional application No. 61/540,384, filed on Sep. 28, 2011.
(60) Provisional application No. 61/594,230, filed on Feb. 2, 2012.

(51) Int. Cl. G06Q 10/08

(52) U.S. Cl. 705/7.12

(57) ABSTRACT

Supply chain management that provides end-to-end supply chain visibility to a supply chain manager. The supply chain management may include aggregation of supply chain snapshot data and supply chain flow data to provide improved end-to-end supply chain visibility to a supply chain manager. In turn, supply chain managers may have improved ability to capitalize on opportunities and mitigate deficiencies in the supply chain to improve revenue and provide increased customer satisfaction and more efficient logistics in the supply chain.

### CROSS REFERENCE TO RELATED APPLICATIONS

This application claims priority to U.S. Provisional Application No. 61/540,384 filed on Sep. 28, 2011 entitled “SYSTEM AND METHOD FOR ANALYZING AND PRESENTING SUPPLY, FABRICATION, AND LOGISTICS DATA” and U.S. Provisional Application No. 61/594,230 filed on Feb. 2, 2012 entitled “TOOLS FOR ANALYZING AND PRESENTING SUPPLY, FABRICATION, AND LOGISTIC DATA”, the entirety of each being incorporated by reference herein.

### BACKGROUND

Supply chain management generally describes approaches to the management of procuring, producing, and delivering products and services to customers. Accordingly, supply chain management may involve the management of material, information, and/or funds between trading partners in a supply chain. The complexity of supply chain management has increased as modern supply chains have become increasingly fragmented and complex. For example, the number of trading partners an entity may do business with in a supply chain has grown with the addition of expanding numbers of component suppliers, manufacturers, distribution mechanisms, and the like.

Furthermore, changes in the marketplace continue to occur rapidly. For example, increasing development in emerging markets, quicker product development timeframes, turbulent economic factors, and a more geographically diverse supply chain introduce challenges to supply chain management to adjust to the ever changing marketplace. In this regard, increasingly rapid changes in the supply chain compounded with an increasingly fragmented supply chain presents a number of difficulties in the ability to adapt to market conditions to successfully manage a supply chain. As such, supply chain managers may have a difficult time managing global supply chains. For example, supply chain managers may have limited visibility of the supply chain. The limited visibility of the supply chain may impact the ability to effectively plan and manage a supply chain. Accordingly the continued need for improved supply chain management exists including mechanisms for improving end-to-end visibility in a supply chain.

### SUMMARY

A first aspect described herein includes a supply chain management system. The system includes an integration layer in operative communication with at least a first trading partner to receive from the first trading partner supply chain snapshot data regarding the first trading partner and supply chain flow data related to the first trading partner. The system also includes a data aggregation layer operable to analyze the supply chain snapshot data and the supply chain flow data to define validated supply chain status data. The system also includes a management layer operable to present the validated supply chain status data to a user.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For example, in an embodiment, the analysis of the supply chain snapshot data and the supply chain flow data may include modifying at least a portion of the supply chain snapshot data based on the supply chain flow data. The supply chain snapshot data may include asynchronous supply chain snapshot data from the first trading partner and at least a second trading partner. The asynchronous snapshot data may include first supply chain snapshot data from the first trading partner at a first time and second supply chain snapshot data from the second trading partner at a second time. The asynchronous supply chain snapshot data may include at least one inconsistency based on a change in a supply chain status of at least one of the first trading partner or the second trading partner between the first time and the second time. The supply chain flow data may be indicative of the inconsistency, and the inconsistency may be removed from the validated supply chain data at least partially based on the supply chain flow data.

In an embodiment, the management layer may be operable to perform a business process flow at least partially based on the validated supply chain status data. The business process flow may include at least one of a forecast collaboration process, an order management process, a data quality process, an inventory management process, an excess and obsolescence monitoring process, or an inventory redistribution process. Accordingly, in response to the business process flow, the management layer may communicate business process flow data to the data aggregation layer. The data aggregation layer may communicate the business process flow data to at least the first trading partner.

In an embodiment, the management layer may be operable to calculate at least one key performance indicator (KPI) based on the validated supply chain data indicative of the performance of the first trading partner relative to a predetermined supply chain management plan. Accordingly, the management layer may include a dashboard, wherein the at least one KPI is graphically displayed to the user.

In an embodiment, the supply chain snapshot data may include material requirement planning (MRP) data. Additionally, the supply chain flow data may correspond to inter-site data exchanged between the first trading partner and at least a second trading partner. In an embodiment, the supply chain flow data may comprise electronic data interchange (EDI) messages. In various embodiments, the supply chain flow data may correspond to flow data in other appropriate formats such as, for example, alternative formats of system-to-system messaging, spreadsheets, email messages, phone calls, etc. In an embodiment, the analysis of the supply chain snapshot data and the supply chain flow data may be performed autonomously.

A second aspect includes a method for supply chain management using a computer-based supply chain management system. The method includes receiving at least supply chain snapshot data and supply chain flow data at a computer-based supply chain management system from at least first trading partner. The supply chain snapshot data includes material requirement planning (MRP) data indicative of a status of the first trading partner at a first time. The flow data includes inter-site data exchanged between the first trading partner and at least a second trading partner. The method further includes aggregating the supply chain snapshot data and the supply chain flow data received from the at least one trading partner using the computer-based supply chain management system. The aggregating includes validating the supply chain snapshot data and the supply chain flow data to define validated supply chain data. The method also includes monitoring, using the computer-based supply chain management system, a supply chain status of the first trading partner based on the validated supply chain data.

A number of feature refinements and additional features are applicable to the second aspect. These feature refinements and additional features may be used individually or in any combination. As such, each of the following features that will be discussed may be, but are not required to be, used with any other feature or combination of features of the second aspect.

In an embodiment, the method may also include generating, in response to the monitoring, actionable business intelligence for use in supply chain management. In an embodiment, the monitoring comprises calculating at least one key performance indicator (KPI) based on the validated supply chain data indicative of performance of the first trading partners relative to a predetermined supply chain management plan. As such, the method may also include presenting the at least one KPI to a user in a graphical format.

In an embodiment, the method may also include communicating a business process flow to the first trading partner. The business process flow may be at least partially based on the validated supply chain data, and the business process flow may define a change to the predetermined supply chain management plan. For example, the business process flow may include at least one of a forecast collaboration process, an order management process, a data quality process, an inventory management process, an excess and obsolescence monitoring process, or an inventory redistribution process.

In an embodiment, the aggregating may include modifying the supply chain snapshot data based on the supply chain flow data.

A third aspect includes a method for supply chain management. The method includes aggregating supply chain snapshot data and supply chain flow data from at least one trading partner to generate validated supply chain data regarding the trading partner. The method further includes monitoring, at a computer-based supply chain manager, at least one key performance indicator (KPI) regarding the trading partner based on the validated supply chain data. Further still, the method includes generating, at the computer-based supply chain manager, an alert based on a value of the KPI. The method also includes determining, at the computer based supply chain manager, a corrective action involving the trade partner. Additionally, the method includes communicating a business flow from the computer-based supply chain manager to the trade partner regarding the corrective action. The method also includes receiving revised snapshot data and revised flow data for the trading partner after communicating the business flow. The method further includes tracking compliance of the trade partner with respect to the business flow based on the aggregated revised snapshot data and the revised flow data received from the trading partner.

### BRIEF DESCRIPTION OF THE FIGURES

FIG. 1 illustrates an embodiment of a supply chain and corresponding data exchange between trade partners in the supply chain.

FIG. 2 illustrates an embodiment of a method of supply chain management.

FIGS. 3A-3C illustrate an embodiment of a supply chain with inconsistencies based on limited supply chain visibility.

FIG. 4 illustrates an embodiment of a supply chain facilitating validated supply chain data for eliminating the inconsistency illustrated In FIGS. 3A-3C.

FIGS. 5A-5C illustrate another embodiment of a supply chain with inconsistencies based on limited supply chain visibility.

FIG. 6 illustrates an embodiment of a supply chain facilitating validated supply chain data for eliminating the inconsistency illustrated in FIGS. 5A-5C.

FIG. 7 illustrates an embodiment of a supply chain management system operative to analyze supply chain snapshot data and supply chain flow data to provide validated supply chain data for use in supply chain management.

FIGS. 8A-8D illustrate embodiments of dashboard displays for presenting validated supply chain data to a user.

### DETAILED DESCRIPTION

Any individual or organization operating a supply chain may face complex supply chain management issues. One proposed approach to supply chain management includes sending spreadsheets and email messages between people and organizations to communicate supply chain status planning and status information, and authorization to take action. However, use of such non-specific, non-integrated tools may present additional challenges to the supply chain management process. For example, supply chain managers may be charged with integration of all the information contained in and shared by the distribution of spreadsheets in order to construct a global view of the supply chain or a portion for which the supply chain manager is responsible.

A further approach includes complementing spreadsheets and email messages with more structured forms of communications. One such approach includes assembling copies of transactions that flow between nodes (e.g., trading partners) in the supply chain, such as EDI messages and their equivalents. Accordingly, this approach may include assembling copies of flow data corresponding to transactions, movements, or resource delegations that are exchanged between trading partners in the supply chain. For example, E2open, Inc. of Foster City, Calif. is a leading champion of this approach. Another approach includes generating asynchronous snapshot data of material requirement planning (MRP) information of each supply chain node within the supply chain. For example, Kinaxis of Ottawa, Ontario Canada is a leading champion of this approach.

The first approach of copying flow data alone may give an accurate picture of the product flows between supply chain nodes (such as a factory, supplier, distribution center, inventory hub, etc.), but it does not give visibility to the activities and plans within a supply chain node. Therefore this approach does not yield the information necessary to plan across the end-to-end supply chain.

The second approach of copying snapshot data corresponding to different trading partners in the supply chain can give an accurate picture of what is happening and being planned within each individual trading partner, but it is difficult to tightly integrate the data from multiple trading partners because the snapshot data is typically acquired independently and asynchronously at each trading partner. Accordingly, this approach is very data dependent. For it to operate correctly, the data from all the systems feeding data to the supply chain manager must have accurate, timely data. In practice, this can be very difficult to achieve. Additionally, the data from the various trading partners can have different coding conventions and different meanings. Since this data comes from the operational systems within the various supply chain trading partners, it is difficult to change data formats and content to drive consistency between nodes, since these changes can impact the operational processes occurring within the supply chain trading partner.

As such, because these approaches include incomplete data from which supply chain plans cannot be managed or asynchronous snapshots of portions of the supply chain, neither provide a quantity consistent view of the supply chain. Additionally, given the increasing number of trading partners included in supply chains and the increasing complexity of relationships between trading partners, the standardization of approaches to sharing data may be burdensome. Furthermore, given the fragmented and dispersed nature of modern supply chains, it may be very difficult to determine if individual actors within the supply chain are implementing the plans approved by the supply chain manager.

In view of these difficulties, traditional supply chain management may rely on assumptions, approximations, and estimates to account for the inability to accurately visualize the supply chain in substantially real time. As such, the assumptions, approximations, and estimates in the supply chain management plan, especially in light of the rapid changes that occur in modern supply chains, often result in supply chain managers making crucial decisions without an accurate picture of the supply chain or without key information regarding how the decision will affect the supply chain. In turn, poor decisions may be made resulting in increased costs; inefficient inventory utilization; delaying the ability to respond to changes in supply, demand, and pricing; or the like. Accordingly, the potential for lost revenue, customer dissatisfaction, or other negative outcomes is heightened.

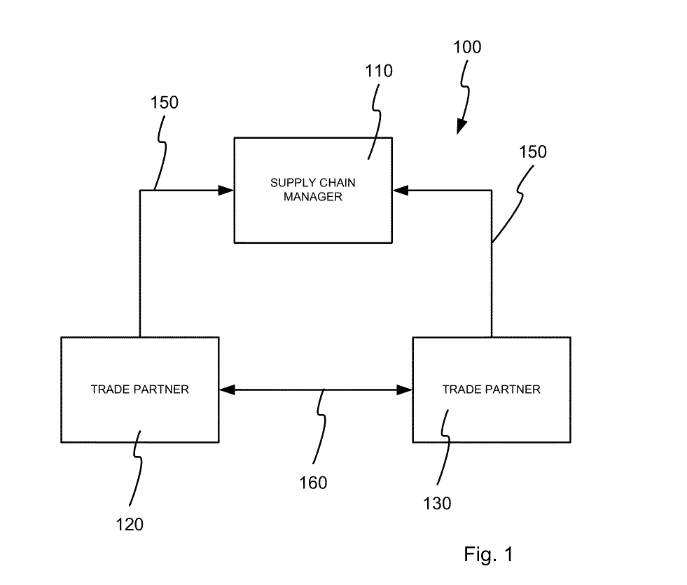

Turning to FIG. 1, an embodiment of a supply chain 100 is illustrated. The supply chain 100 may include a supply chain manager 110. Furthermore, one or more trade partners (e.g., trade partner 120 and/or trade partner 130) may be provided in the supply chain 100. For the purpose of the discussion with respect FIG. 1, the nature of the supply chain manager 110, trade partner 120, and trade partner 130 is not important. For example, the supply chain manager 110 may be a contract manufacturer, brand owner, component supplier, wholesaler, retailer, repair facility, warehouse, logistical support provider, and/or other entity in the supply chain 100 without limitation. Similarly, trading partner 120 and/or trading partner 130 may be any of the foregoing supply chain entities without limitation.

In any regard, the various entities depicted in FIG. 1 may be capable of communicating data between the entities. The communication of data between the various entities may be direct such that the data is provided directly by a first trade partner (e.g., trade partner 120) to the second trade partner (e.g., trade partner 130). Alternatively, data may be exchanged between the various entities depicted in FIG. 1 indirectly such that communications are exchanged through various entities prior to arriving at the destination entity. In another embodiment, each entity shown in FIG. 1 may be in operative communication with supply chain network (not shown in FIG. 1) that is capable of communication between the entities of the supply chain 100.

In any regard, supply chain manager 110 may be operative to receive data from trade partner 120 and trade partner 130 regarding a supply chain status of the corresponding entity. The data may be provided in a number of potential formats or messaging techniques and may correspond to different supply chain management paradigms utilized in the art. For example, the data provided to the supply chain manager 110 may include supply chain flow data 160 and supply chain snapshot data 150.

For example, as described above, in one potential approach to supply chain management, trade partners may provide supply chain snapshot data that corresponds to the supply chain status of the trade partner at a moment in time. For example, trade partner 120 may generate a representation of the supply chain status of the trade partner 120 at a first time. In turn, the trade partner 120 may provide this snapshot data 150 to the supply chain manager 110.

The snapshot data 150 may correspond to material requirements planning (MRP) data associated with the trade partner 120 at the first time. The MRP data may be data used in manufacturing, inventory management, purchasing, sales, marketing, or other supply chain functions. In this regard, MRP data may include inventory control data, bill of material processing data, scheduling data, order data, demand data, or other data indicative of the supply chain status of the trade partner 120. Furthermore, the MRP data may include recommended production schedule outputs that may include detailed schedules for required minimum start and completion dates, quantities, steps of the routing of a product, bill of materials required to satisfy demand for a master production schedule, etc. The MRP data may also include a recommended purchasing schedule that includes both the dates that the purchased items should be received into a facility and the dates that the purchase orders, blanket order release, or other purchase document should occur to match production schedules. The MRP data may include purchase orders and/or reschedule notices. Further still, the MRP data may also include data regarding parameters used in algorithms employed by the MRP systems of a trade partner. For example, the MRP data may correspond to parameters of a trade partner's MRP system that control processing of exceptions in the supply chain. For instance, the MRP data may include data corresponding to how a trade partner's MRP system handles orders that cannot be delivered in-full and on-time such as if and/or how the order is to be split into partial shipments. In various other embodiments, MRP data may include other appropriate data relating to inventory, manufacturing schedules, or other logistical data regarding trade partner 120 at the first time.

In any regard, is important to note that all of the MRP data included in the snapshot data provided by trade partner 120 to supply chain manager 110 may reflect the status of trade partner 120 only at the instant in time corresponding with the first time. That is, the snapshot data that correspond only to the time in which it is taken and may not reflect changes that occurred prior to or may occur after the snapshot is taken.

As depicted in FIG. 1, trade partner 120 may provide snapshot data 150 to the supply chain manager 110 and trade partner 130 may provide snapshot data 150 to the supply chain manager 110. Supply chain manager 110 may also produce snapshot data 150 indicative of a supply chain status of the supply chain manager 110 for analysis with respect to the snapshot data received from trade partner 120 into a partner 130.

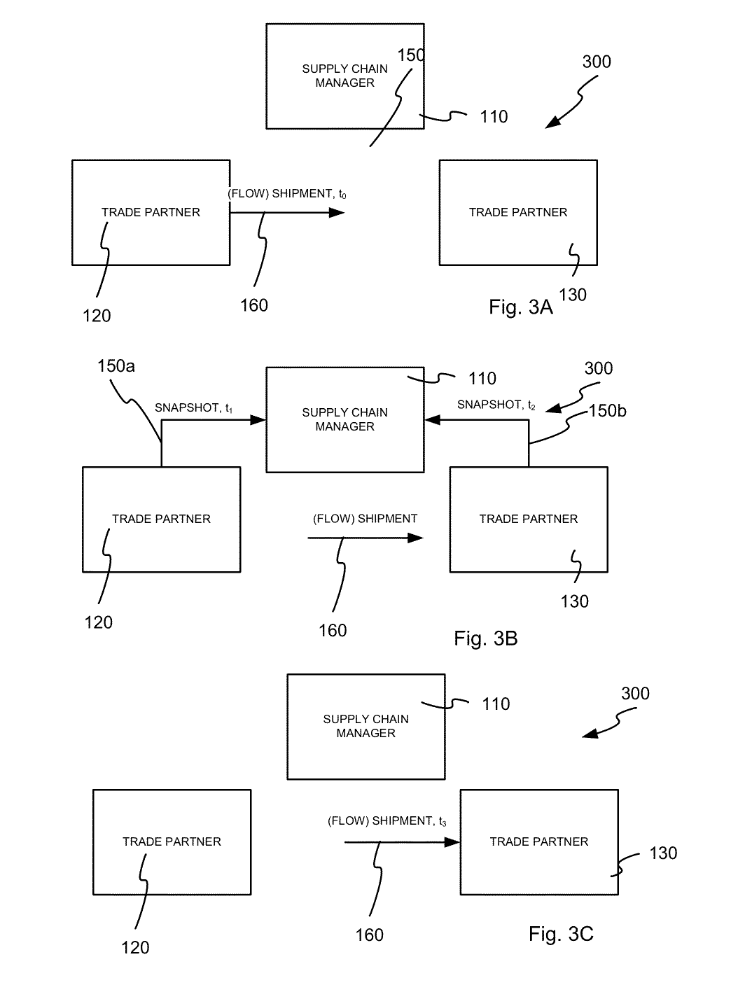

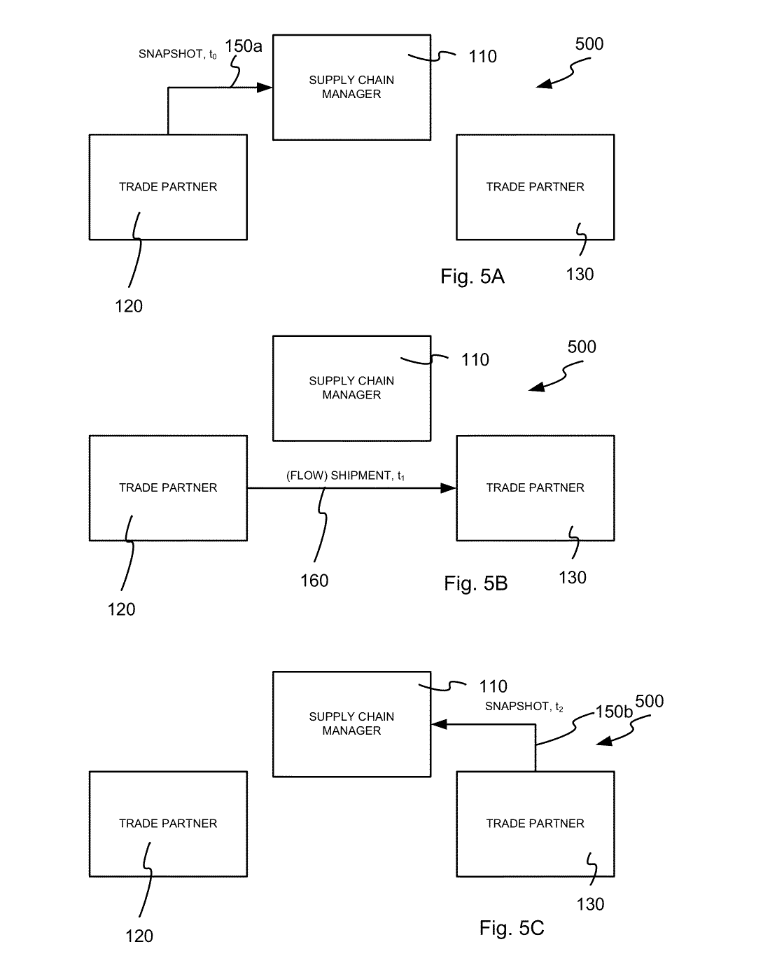

Each of the snapshot data 150 corresponding to the different entities in the supply chain 100 may be asynchronous. That is, each of the snapshot data 150 may correspond to the status of a respective entity at different moments in time. In this regard, it may be appreciated, as will be further illustrated below in FIGS. 3A-3C and FIGS. 5A-5C, the asynchronous nature of the snapshot data 150 may introduce inconsistencies in data at the supply chain manager 110.

Another supply chain management technique may include the provision of supply chain flow data between trading partners. For example, shown in FIG. 1, trade partner 120 and trade partner 130 may exchange flow data 160. The flow data 160 may correspond to a transaction between trade partner 120 and trade partner 130. For example, the flow data 160 may correspond to orders issued from one trade partner to the other trade partner, material movements between one trade partner and another trade partner, purchase orders provided from one trade partner to another trade partner, bills of material provided from one trade partner to another trade partner, manufacturing schedules provided from one trade partner to another trade partner, or other supply chain data involving the movement of materials, data, funds, or other resources between one trade partner and another trade partner. The flow data 160 may be in the form of electronic data interchange (EDI) messages that follow a predetermined format agreed upon by trade partners in the supply chain 100. While not shown in FIG. 1, it may also be understood that each of the trade partners 120 or trade partner 130 may also provide the flow data 160 to the supply chain manager 110. That is, supply chain manager 110 may be involved in the issuance or receipt of flow data 160 from trade partner 120 or trade partner 130. Further still, the supply chain manager 110 may receive copies of flow data 160 from one or more third parties such as a business-to-business exchange or a logistics service provider (e.g., a carrier or the like).

In any regard, the flow data 160 may be issued in conjunction with transaction or exchange of a resource between trade partners. In addition, copies of the flow data 160 indicative of the nature of the transaction or exchange may be provided to the supply chain manager 110. As described above, while the flow data 160 may provide insight to the supply chain manager 110 with respect to the flow of resources within the supply chain 100, the flow data 160 may not provide full visibility into the status of the trade partners in the supply chain 100. In this regard, levels of inventory, production schedules, demand, resource utilization forecasts, or other supply chain status data may not be ascertained based on flow data 160 alone.

It may be appreciated that the supply chain 100 depicted in FIG. 1 may be a much simplified version of actual implementations of supply chains. This regard, it will be appreciated that additional trading partners may be provided in addition to those shown in FIG. 1. As such, snapshot data 150 and/or flow data 160 may be provided between any trade partners of a supply chain to coordinate activities between trade partners in the supply chain.

However, it is currently recognized that the use of snapshot data 150 or flow data 160 in isolation may result in inconsistencies and/or errors in supply chain data used in the management of the supply chain due to the respective issues with either approach discussed above. In this regard, a supply chain manager 110 tasked with monitoring and/or managing a supply chain 100 based only on snapshot data 150 or only on flow data 160 or some nonintegrated combination thereof may be required to make assumptions, approximations, or estimates when making decisions with respect to actions in the supply chain 100. For example, FIGS. 3A-3C and 5A-5C discussed in greater detail below depict examples of inconsistencies that may occur in supply chain data based on the exclusive use of snapshot data 150 or flow data 160.

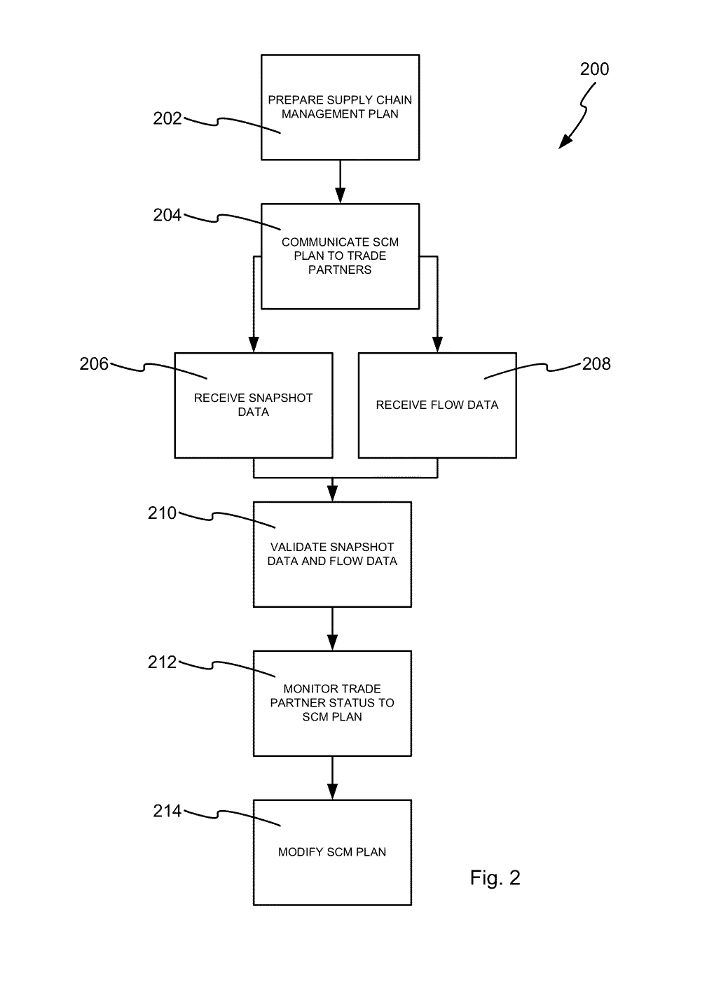

In this regard, FIG. 2 illustrates a process 200 for use in supply chain management that may provide integration of snapshot data 150 and flow data 160 from one or more trading partners for use to provide validated supply chain data. In this regard, the validated supply chain data may provide an accurate picture of the status of the supply chain (e.g. increase end-to-end supply chain visibility). Based on the increased visibility of the supply chain reflected in the validated supply chain data, strategic supply chain decisions, supply chain monitoring, hypothetical supply chain scenario modeling, or other operations associated with supply chain management may be executed without the need for assumptions, approximations, or estimates.

The process 200 may include preparing 202 a supply chain management plan. The supply chain management plan may include production goals, production plans, demand forecasts, or other supply chain data corresponding to the intended function of one or more trade partners in a supply chain.

The process 200 may further include communicating 204 supply chain management plan to trade partners for execution of the supply chain management plan by the trade partners. In turn, the trade partners may proceed with execution of the supply chain management plan by, for example, ordering inventory, communicating with other suppliers in supply chain, conducting manufacturing activities, or other supply chain activities related to the supply chain management plan. In turn, the supply chain status of each of the supply chain partners may dynamically change to reflect the activities of the trade partners in the supply chain. Furthermore, the status of the trade partners may be affected by other factors such as, for example, natural disasters, political factors, or other external factors that affect the supply chain status of the trade partner. The supply chain status of the various trade partners in the supply chain may be reflected in snapshot data and/or flow data generated at the various trade partners.

As such, the trade partners may provide snapshot data and flow data to a supply chain manager. In this regard, the supply chain manager may receive snapshot data 206 and receive flow data 208 from trade partners indicative of supply chain activities executed by the trade partners. The received snapshot data 206 and received flow data 208 may be raw snapshot data and raw flow data, respectively, generated in the normal course of operation of the trade partners.

Accordingly, the supply chain manager may then validate 210 snapshot data and flow data to provide validated supply chain data. As will be discussed in greater detail below, the validation may include analyzing snapshot data and flow data to supplement, modify, correct, or otherwise alter one of the snapshot data and flow data to provide validated supply chain data. Furthermore, the validating 210 may include identifying inconsistencies between snapshot data and flow data and resolving the inconsistency based on a collective analysis of the snapshot data and flow data. Furthermore, the validating 210 may include normalizing received snapshot data 206 and received flow data 208. For example, the snapshot data and/or flow data received from different trading partners may include inconsistencies with respect to identification of resources (e.g., use of different part numbers, product numbers, etc.), may include different information formats, may include different information content, or be otherwise inconsistent. In turn, the data may be normalized to eliminate at least one such inconsistency.

In an embodiment, the inconsistency of one type of a data (e.g., snapshot data) may be reflected in another type of data (e.g., flow data). For example, a part may be referred to by a first trading partner with a first part number utilized internally by the first trading partner. The same part may be referred to by a second trading partner with a different second part number utilized internally by the second trading partner. As such, snapshot data received from the first and second trading partner may reflect each partner having a certain inventory of two different parts, when in reality the part referenced by the different part numbers is identical.

It may also be that associated flow data indicates the inconsistency. For example, a bill of lading sent from the first trade partner to the second trade partner associated with a shipment of the part from the first trade partner to the second trade partner may include data associating the first part number with the second part number. As such, a supply chain manager may be operative to analyze the snapshot data provided by the first and second trade partners in combination with a copy of the flow data from at least one of the first and second trade partners to resolve the inconsistency. In this regard, the end-to-end inventory level (i.e., the inventory of the part throughout the supply chain being monitored) may accurately reflect the inventory of the part, rather than showing discrete inventory levels for the two part numbers used by the trading partners. That is, the validated supply chain data may accurately reflect the end-to-end supply chain status based on analysis of snapshot data and flow data. The validating 210 may also include other instances of generating validated supply chain data as will be better illustrated in FIGS. 3A-3C and FIGS. 5A-5C discussed below.

In an embodiment, the validating 210 may be performed autonomously. The receiving snapshot data 206 and receiving flow data 208 may occur periodically such that the validating 210 to generate validated supply chain data may also occur periodically (e.g., may coincide with receipt 206 and/or 208 of the snapshot or flow data, respectively). Alternatively, the receiving 206 and/or receiving 208 may occur continuously such that substantially real-time validated supply chain data may also be continuously generated.

Accordingly, the process 200 may further include monitoring 212 trade partner statuses with respect to supply chain management plan based on the validated supply chain data generated during the validating 210. For example, a key performance indicator (KPI) may be calculated that is indicative of the performance of one or more trade partners relative to the supply chain management plan based on an analysis of the validated supply chain data. The KPI may be displayed to a user in a graphical format. For example, a dashboard may be generated that presents one or more KPIs to a user. The dashboard may be a web-based portal that allows a supply chain manager to view an end-to-end supply chain status based on the validated supply chain data. Based on the monitoring 212, deficiencies in the supply chain (e.g., deadline non-compliance, inventory mishandling, inventory inefficiencies, mismatched supply/demand rates, etc.) may be identified by a supply chain manager.

In this regard, the process 200 may further include modification 214 to the supply chain management plan based on the monitored status of the trade partners with respect to the supply chain management plan. For example, the modification 214 of the supply chain management plan may include a business process flow corresponding to a corrective action based on a deficiency identified during the monitoring 212. The business process flow may correspond to, for example, one or more of a forecast collaboration process, an order management process, a data quality process, an inventory management process, an excess and obsolescence monitoring process, or an inventory redistribution process. As such, the identified deficiencies may be alleviated or mitigated based on the monitoring 212 of the validated supply chain data.

Furthermore, the accurate end-to-end visibility of the supply chain that the validated supply chain data provides may allow a supply chain manager to capitalize on opportunities. For example, opportunistic orders may be received where a brand owner provides a conditional order if the ordered products may be delivered by a certain time. The end-to-end visibility provided by the validated supply chain data may allow a supply chain manager to accurately determine whether the opportunistic order may be fulfilled. Furthermore, because the validated supply chain data may provide real-time, accurate visibility into the end-to-end supply chain, a supply chain manager may be operable to identify modification or variances that may be made in order to comply with an opportunity. In this regard, the visibility provided by the validated supply chain data may allow a supply chain manager to mitigate loss and capitalize on increased revenue opportunities.

With further reference to FIG. 3A-3C, a scenario in which the exclusive provision of snapshot data 150 or flow data 160 introduces inconsistencies with respect to the status of a supply chain 300 data is depicted. FIG. 3A may correspond to a time t₀ in the supply chain 300. At time t₀, trade partner 120 may initiate a transaction between trade partner 120 and trade partner 130. The transaction may, for example, correspond with a shipment of inventory from trade partner 120 to trade partner 130. The transaction may include communication of a flow data message 160 corresponding to the shipment of inventory from trade partner 120 to trade partner 130. As may be appreciated, at time t₀, the inventory associated with the shipment may leave the inventory of trade partner 120 and be provided to a carrier for transport between trade partner 120 and trade partner 130. In this regard, the inventory associated with the shipment described by flow data 160 may be in transit at time t₀ such that the inventory may not be captured in snapshot data of either trade partner 120 or trade partner 130 once the carrier receives the inventory, but before the inventory is received at the trade partner 130.

As such, FIG. 3B corresponds to a period of time after time t₀. As shown in FIG. 3B, trade partner 120 may provide snapshot data 150a corresponding to the status of trade partner 120 at time t₁ to supply chain manager 110. Also, trade partner 130 may provide snapshot data 150b corresponding to the status of trade partner 130 at time t₂ to supply chain manager 110. As depicted in FIG. 3B, at time t₁ the inventory associated with the shipment may have already left the inventory of trade partner 120 such that the inventory associated with the shipment is not included in the snapshot data 150a. Furthermore, the inventory associated with the shipment may not have yet arrived at trade partner 130 at time t₂ when the snapshot data 150b is provided from trade partner 130 to supply chain manager 110.

In this regard, the asynchronous snapshot data 150a take at time t₁ and snapshot data 150b taken at time t₂ may not reflect the inventory in transit between trade partner 120 and trade partner 130 between times t₁ and t₂. As such, the inventory associated with the shipment between trade partner 120 and trade partner 130 may go unaccounted for in the supply chain status generated at the supply chain manager 110 based on the communication of snapshot data 150a and 150b to supply chain manager 110. Additionally, it may be noted that the inconsistency may still be present even if the snapshot data 150a and 150b is synchronous as neither portions of snapshot data 150a or 150b may account for the inventory in transit.

As depicted in FIG. 3C, at time t₃ after snapshot data 150a and snapshot data 150b is provided supply chain management 110, the inventory associated with the shipment between trade partner 120 and trade partner 130 may arrive at the trade partner 130. However, the supply chain manager 110 may be unaware of the inventory associated with the shipment given the fact the inventory was in transit at the time trade partner 120 and trade partner 130 provided their snapshot data 150a and 150b, respectively, to supply chain manager 110.

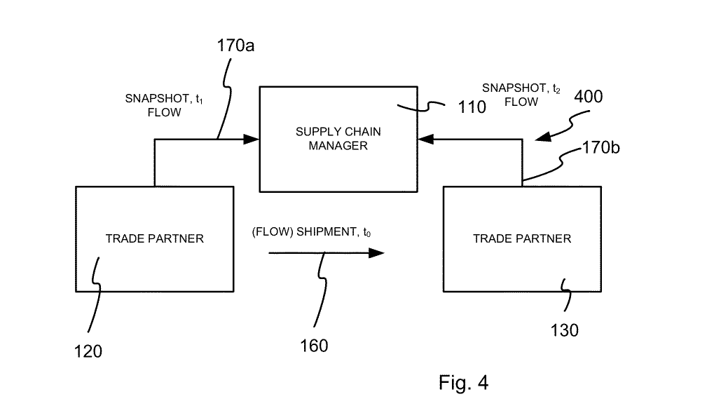

However, with further respect to FIG. 4, a supply chain 400 may be provided that practices an embodiment of a method similar to process 200 described in FIG. 2. That is, trade partner 120 may provide a communication 170a to supply chain manager 110. The communication 170a may include snapshot data corresponding to time t₁ as well as the flow data 160 corresponding to the shipment of the inventory between trade partner 120 trade partner 130 at time t₀ prior the snapshot data taken at time t₁. Additionally or alternatively, trade partner 130 may provide a communication 170b to supply chain manager 110 that includes snapshot data associated with time t₂ as well as the flow data 160 corresponding to the shipment of inventory between trade partner 120 and trade partner 130.

In this regard, supply chain manager 110 may be operable to analyze the combination of snapshot data 150a, 150b and flow data 160 received in communications 170a and 170b from trade partner 120 and trade partner 130 to determine that the inventory associated with the flow data 160 may be attributed to trade partner 130 given the inventory is in transit to trade partner 130 despite the fact that snapshot data 150b may not yet reflect the receipt of the inventory. Accordingly, rather than snapshot data for each of the individual trade partners 120 and 130 being considered alone, flow data 160 in addition to snapshot data 150 may be analyzed by the supply chain manager to account for the inventory in transit between trade partner 120 and trade partner 130. It may further be appreciated that with the addition of additional trade partners and added complexity of the exchange of data, material, or other resources between trade partners, the amount of inventory, material, products, or other resources that may go unaccounted for based on the inconsistencies introduced due to the use asynchronous snapshot data 150a, 150b alone may be significant.

With further reference to FIGS. 5A-5C, another scenario in which snapshot data 150 alone may not accurately indicate the status of trade partners 120 and 130 in a supply chain 500 is depicted. In the supply chain 500, trade partner 120 may provide snapshot data 150a corresponding to time t₀ to supply chain manager 110. In FIG. 5b, trade partner 120 may initiate a shipment of inventory between trade partner 120 and trade partner 130. In conjunction with the shipment of inventory, the trade partner 120 may send flow data 160 corresponding to time t₁ to trade partner 130. Subsequent to the shipment of inventory corresponding to flow data 160, as shown in FIG. 5C, trade partner 130 may provide snapshot data 150b to supply chain manager 110 corresponding to the status of trade partner 130 at time t₂ which may be after receipt of the inventory associated with flow data 160.

In this regard, the snapshot data 150a provided by trade partner 120 to the supply chain manager 110 may include an indication that the trade partner 120 is in possession of the inventory associated with the flow data 160. Furthermore, because the snapshot data 150b may be sent by trade partner 130 asynchronously from snapshot data 150a, trade partner 130 may have already received the inventory associated with flow data 160 such that the inventory is also included in the snapshot data 150b provided to the supply chain manager 110.

Accordingly, the inventory corresponding to the shipment between trade partner 120 and 130 may be inflated due to the inconsistencies introduced in the asynchronous collection of snapshot data 150a and 150b. Such a scenario may be particularly likely in the case of relatively close geographic trade partners that take snapshot data at different time periods.

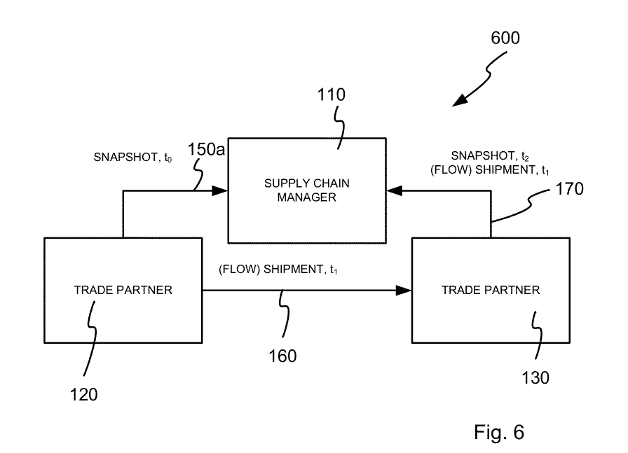

However, as shown in FIG. 6, a supply chain 600 is depicted where trade partner 120 may provide snapshot data 150a to supply chain manager 110 corresponding to the state of trade partner 120 at time t₀. As such, snapshot data 150a may include inventory at trade partner 120 that is to be shipped to trade partner 130. Accordingly, subsequent to time t₀ at time t₁, trade partner 120 may initiate the shipment of inventory to trade partner 130 and provide flow data 160 to trade partner 130 corresponding to the shipment of inventory between trade partner 120 and trade partner 130. At a subsequent time, t₂, trade partner 130 may provide supply chain manager 110 a communication 170. The communication may include snapshot data 150b corresponding to the status of the trade partner at time t₂. The shipment may have been received at trade partner 130 prior to time t₂. As such, the inventory associated with the shipment may also be reflected in the snapshot data provided by trade partner 130 at time t₂. Additionally, the communication 170 may also include the flow data 160 corresponding to the shipment initiated a time t₁ indicating the shipment of inventory. In this regard, the supply chain manager 110, upon analysis of the communication 170 including snapshot data 150b and flow data 160 may account for the inventory that may be included in snapshot data 150a and 150b and determine that the inventory is no longer present at trade partner 120. In this regard, supply chain manager 110 may correctly account for the inventory associated with the flow data 160 as being in transit or provided at trade partner 130 such that the inventory is accurately accounted for in validated supply chain data at the supply chain manager 110.

In this regard, it may be appreciated that validated supply chain data derived by analysis of snapshot data and flow data provided by trade partners may provide a more accurate end-to-end supply chain status of the supply chain at a supply chain manager. The increased end-to-end supply chain visibility provided may allow the supply chain manager to more accurately track compliance with respect to supply chain management plan. In turn, a supply chain manager may be operative to alter a supply chain management plan based on actual performance of trade partners relative to a predetermined supply chain plan to capitalize on opportunities and/or mitigate deficiencies identified in the supply chain.

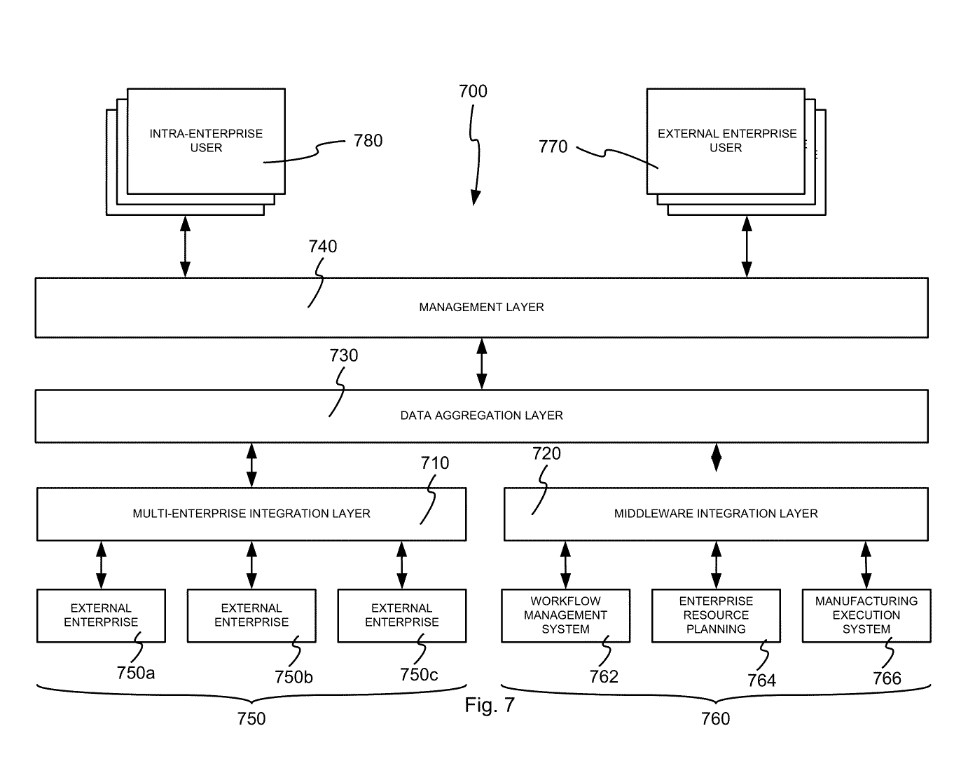

FIG. 7 depicts one supply chain structure 700 in which a supply chain management technique per process 200 described above with respect FIG. 2 may be implemented. The supply chain 700 may include a multi-enterprise integration layer 710, a middleware integration layer 720, a data aggregation layer 730, and a management layer 740. The multi-enterprise integration layer 710, the middleware integration layer 720, the data aggregation layer 730, and the management layer 740 may be provided at a supply chain manager. As discussed above with respect to FIG. 1, the supply chain manager may be a brand owner, manufacturer, or other entity in the supply chain tasked with oversight over at least a portion of the supply chain.

The multi-enterprise integration layer 710 may be in operative communication with a plurality of external enterprises 750. The external enterprises 750 may be entities distinct from the supply chain manager. External enterprises 750a, 750b, and 750c may all provide flow data and/or snapshot data to the multi-enterprise integration layer 710.

Furthermore, the middleware integration layer 720 may be in operative communication with one or more inter-enterprise resources 760. That is, the inter-enterprise resources 760 may be located or provided by the same entity as the supply chain manager. For example, a workflow management system 762, an enterprise resource planning system 764, and/or a manufacturing execution system 766 may be in operative communication with the middleware integration layer 720. Each of the inter-enterprise resources 760 may provide flow data and/or snapshot data to the middleware integration layer 720.

The multi-enterprise integration layer 710 and middleware integration layer 720 may provide the respective snapshot data and/or flow data received from the external enterprises 750 and intra-enterprise resources 760 to the data integration layer 730. The data integration layer 730 may in turn be operative to validate the snapshot data and flow data received from the various resources in operative communication with the integration layers 710 or 720 to provide validated supply chain data as described above. In turn, the validated supply chain data may be provided to the management layer 740.

The management layer 740 may in turn be operative to utilize the validated supply chain data generated at the data integration layer 730 to provide business intelligence with respect to the supply chain. For example, the management layer 740 may provide intra-enterprise users 780 (i.e., users with affiliation to the supply chain manager) with data corresponding to the validated supply chain data. In an embodiment, this management layer 740 may include a dashboard accessible by intra-enterprise users 780 to evaluate the status of the supply chain based on the validated supply chain data provided by aggregation layer 730.

Additionally, the management layer 740 may provide data to one or more external enterprise users 770 (e.g., users not affiliated with the supply chain manger, but potentially affiliated with a trading partner in the supply chain). In this regard, the external enterprise users 770 may also access a dashboard operative to provide data with respect to at least a portion of the supply chain based on the validated supply chain data generated by the data aggregation layer 730. However, the external enterprise user 770 may have limited access to the validated supply chain data as presented in the dashboard such that only portion of the supply chain data may be provided to the external enterprise user 770. For example, the external enterprise user 770 may be presented only with validated supply chain data filtered such that validated supply chain data with a direct correlation to the specific enterprise with which the external enterprise user 770 is associated with is presented.

In one example, an external enterprise may provide contract manufacturing services to a number of competing brand owners. In this regard, brand owners may be sensitive to the amount of information provided to the contract manufacturer such that only a portion of the data corresponding to the supply chain is provided to an external enterprise user 770 despite the fact end-to-end supply chain visibility may be provided at the management layer 740.

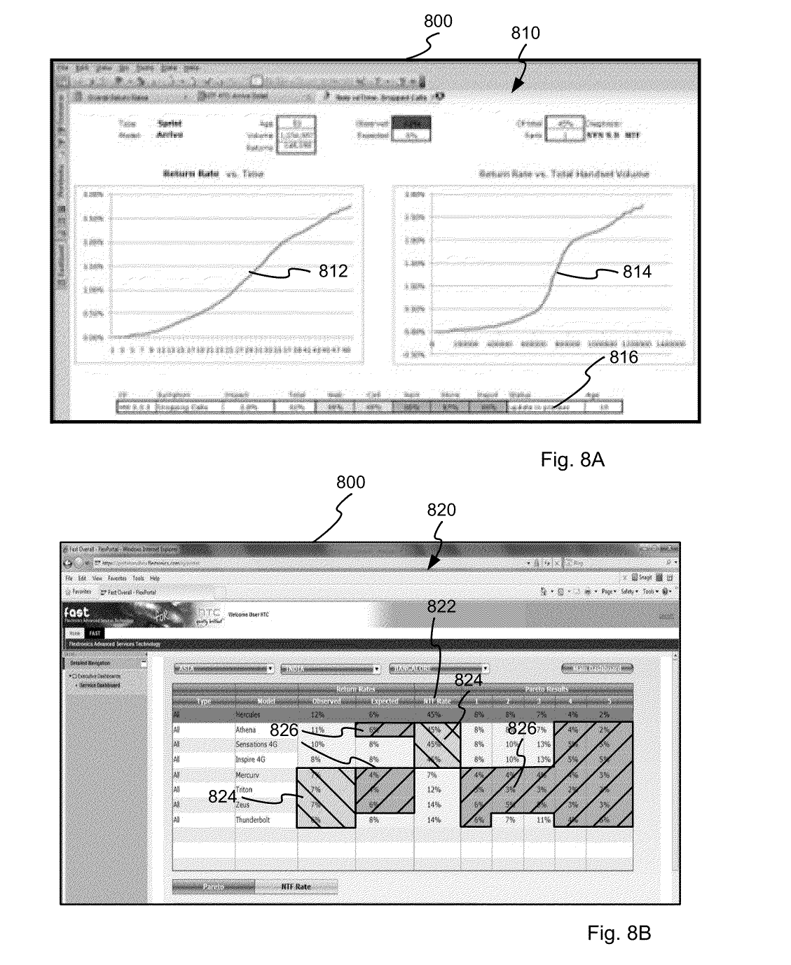

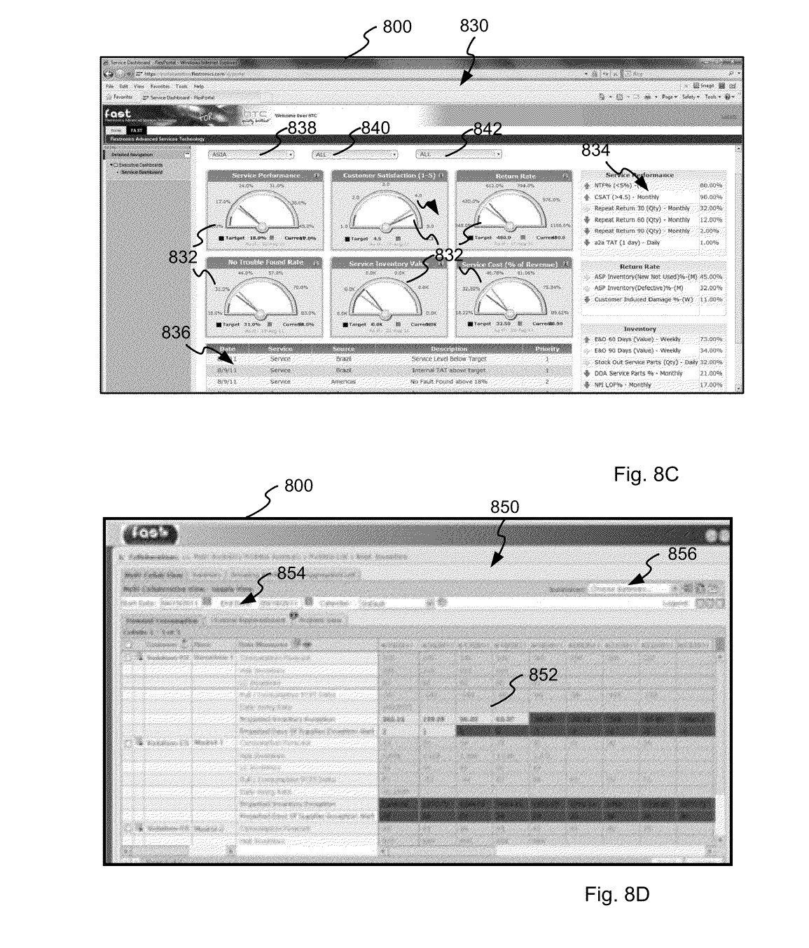

With further reference to FIGS. 8A-8D, various embodiments of dashboard displays 810, 820, 830, and 850 are depicted. Each of the dashboard displays may be presented to a user on a display 800. As described above, the dashboards may correspond to a web portal. The web portal may be accessible by way of entry of a username and password. The username and password may provide information regarding the enterprise to which the users belonged such that the appropriate level of validated supply chain data may be present in the dashboard. Alternatively, the dashboard may be executed as a standalone application executable on a computer, workstation, or the like or may be otherwise executed to provide access to users.

FIG. 8A depicts one potential embodiment of a dashboard display 810. The dashboard display 810 may include a first line graph and/or a second line graph 814 graphically depicting the validated supply chain data. For example, line graph 812 and/or line graph 814 may depict the performance of a trading partner, a KPI, or other appropriate metric determined from the validated supply chain data. Furthermore, a table 816 may be provided to present further details with respect to the line graph 812 and/or line graph 814.

FIG. 8B depicts another embodiment of a dashboard display 20. The dashboard display 820 may include a table 822 presenting information related to validated supply chain data. The table 822 may utilize different colors (e.g., as indicated by differently shaded cells 824 and 826 in FIG. 8B) to represent different indicators (e.g., different alert levels) relative values presented in the table 822. For example, green may indicate a favorable value, yellow may indicate a marginal value, and red may indicate an unfavorable value.

With further reference to FIG. 8C, another embodiment of a dashboard display 830 is shown. The dashboard display 830 may include a plurality of dials 832 that are indicative of information related to validated supply chain data. The dials 832 may include target needles that may reflect a supply chain management plan (e.g. a goal in the plan) and current value needles. Furthermore, textual details provided in a table 836 may be provided. A list of items 834 may also be presented. The list of items may correspond to high-priority issues identified with respect to the supply chain status. For example, alerts related to the validated supply chain data may be presented in the list 834.

Additionally, the information presented in the dashboard display 830 may be filtered based on filtering criteria 838, 840, and 842. For example, a location filter 838 may be provided that filters the data presented in the display 830 to a selected location within the supply chain. For example, the location filter 838 may allow a specific geographic location such as a region, a country, a state, or some combination thereof to be selected such that data related only to the selected geographic location is displayed.

Furthermore, a facility filter 840 may provided that may filter the validated supply chain data based on a selected facility identified in the facility filter 840. For example, validated supply chain data corresponding to different various ones of manufacturing sites, component supplier site, or other specific facility site may be presented based on a selected facility identified using the facility filter 840. Furthermore, product filter 842 may provided such that validated supply chain data corresponding to different products in the supply chain may be presented. Other filtering criteria may be provided without limitation.

FIG. 8D depicts another dashboard display 850. The dashboard display 850 may include a table 852 presenting validated supply chain data to a user. The dashboard screen 850 may include a date filter 854 such that validated supply chain data corresponding to a specific date or range of dates may be presented. Furthermore, another filter 856 may also be provided corresponding to any of the filters 838, 840, or 842 described with respect to FIG. 8C or any other appropriate filter may be employed such that the data displayed in the table 852 may correspond to only selective portions of the validated supply chain data.

Returning to FIG. 7, the multi-enterprise integration layer 710, middleware integration layer 720, data aggregation layer 730, and management layer 740 may all correspond to individual modules executed by a supply chain manager. For example, each of the layers described in FIG. 7 may correspond to discrete processing units capable of performing the functions described above. In this regard, each of the layers may include a processor and/or memory. The memory may contain machine-readable instructions accessible by the processor for execution to facilitate the functionality described above. In an embodiment, one or more of the layers described respect FIG. 7 may be executed by a common processor such that a single processor in operative communication with the single memory may execute one or more the layers described respect FIG. 7.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A supply chain management system, comprising:
an integration layer in operative communication with at least a first trading partner to receive from the first trading partner supply chain snapshot data regarding the first trading partner and supply chain flow data related to the first trading partner;
a data aggregation layer operable to analyze the supply chain snapshot data and the supply chain flow data to define validated supply chain status data; and
a management layer operable to present the validated supply chain status data to a user.

2. A supply chain management system according to claim 1, wherein the analysis of the supply chain snapshot data and the supply chain flow data comprises modifying at least a portion of the supply chain snapshot data based on the supply chain flow data.

3. A supply chain management system according to claim 2, wherein the supply chain snapshot data comprises asynchronous supply chain snapshot data from the first trading partner and at least a second trading partner.

4. A supply chain management system according to claim 3, wherein the asynchronous snapshot data includes first supply chain snapshot data from the first trading partner at a first time and second supply chain snapshot data from the second trading partner at a second time, and wherein the asynchronous supply chain snapshot data comprises at least one inconsistency based on a change in a supply chain status of at least one of the first trading partner or the second trading partner between the first time and the second time.

5. A supply chain management system according to claim 4, wherein the supply chain flow data is indicative of the inconsistency, and wherein the inconsistency is removed from the validated supply chain data at least partially based on the supply chain flow data.

6. A supply chain management system according to claim 1, wherein the management layer is operable to perform a business process flow at least partially based on the validated supply chain status data, wherein the business process flow comprises at least one of a forecast collaboration process, an order management process, a data quality process, an inventory management process, an excess and obsolescence monitoring process, or an inventory redistribution process.

7. A supply chain management system according to claim 6, wherein, in response to the business process flow, the management layer communicates business process flow data to the data aggregation layer, wherein the data aggregation layer communicates the business process flow data to at least the first trading partner.

8. A supply chain management system according to claim 1, wherein the management layer is operable to calculate at least one key performance indicator (KPI) based on the validated supply chain data indicative of the performance of the first trading partner relative to a predetermined supply chain management plan.

9. A supply chain management system according to claim 8, wherein the management layer comprises a dashboard, wherein the at least one KPI is graphically displayed to the user.

10. A supply chain management system according to claim 1, wherein the supply chain snapshot data comprises material requirement planning (MRP) data.

11. A supply chain management system according to claim 10, wherein the supply chain flow data corresponds to inter-site data exchanged between the first trading partner and at least a second trading partner.

12. A supply chain management system according to claim 11, wherein the supply chain flow data comprises electronic data interchange (EDI) messages.

13. A supply chain management system according to claim 12, wherein the analysis of the supply chain snapshot data and the supply chain flow data is performed autonomously.

14. A method for supply chain management, comprising:
receiving at least supply chain snapshot data and supply chain flow data at a computer-based supply chain management system from at least a first trading partner, wherein the supply chain snapshot data includes material requirement planning (MRP) data indicative of a status of the first trading partner at a first time, and wherein the flow data includes inter-site data exchanged between the first trading partner and at least a second trading partner;
aggregating the supply chain snapshot data and supply chain flow data received from the at least one trading partner using the computer-based supply chain management system, wherein the aggregating comprises validating the supply chain snapshot data and the supply chain flow data to define validated supply chain data; and
monitoring, using the computer-based supply chain management system, a supply chain status of the first trading partner based on the validated supply chain data.

15. A method according to claim 14, further comprising:
generating, in response to the monitoring, actionable business intelligence for use in supply chain management.

16. A method according to claim 14, wherein the monitoring comprises calculating at least one key performance indicator (KPI) based on the validated supply chain data indicative of performance of the first trading partners relative to a predetermined supply chain management plan.

17. A method according to claim 16, further comprising:
presenting the at least one KPI to a user in a graphical format.

18. A method according to claim 16, further comprising:
communicating a business process flow to the first trading partner, wherein the business process flow is at least partially based on the validated supply chain data, and wherein the business process flow defines a change to the predetermined supply chain management plan.

19. A method according to claim 18, wherein the business process flow corresponds to at least one of a forecast collaboration process, an order management process, a data quality process, an inventory management process, an excess and obsolescence monitoring process, or an inventory redistribution process.

20. A method according to claim 14, wherein the aggregating comprises modifying the supply chain snapshot data based on the supply chain flow data.

21. A method for supply chain management, comprising:
aggregating supply chain snapshot data and supply chain flow data from at least one trading partner to generate validated supply chain data regarding the trading partner;
monitoring, at a computer-based supply chain manager, at least one key performance indicator (KPI) regarding the trading partner based on the validated supply chain data;
generating, at the computer-based supply chain manager, an alert based on a value of the KPI;
determining, at the computer based supply chain manager, a corrective action involving the trade partner;
communicating a business flow from the computer-based supply chain manager to the trade partner regarding the corrective action;
receiving revised snapshot data and revised flow data for the trading partner after communicating the business flow; and
tracking compliance of the trade partner with respect to the business flow based on the aggregated revised snapshot data and the revised flow data received from the trading partner.
